(19) United States
(12) Patent Application Publication
(10) Pub. No.: US 2008/0025765 A1
(43) Pub. Date: Jan. 31, 2008

(54) Toner-regulating roller having specific surface elastic force, developing apparatus and developing method using the same

(75) Inventor: Takuya Okada, Okazaki-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 11/593,069

(22) Filed: Nov. 6, 2006

(30) Foreign Application Priority Data
Jul. 26, 2006 (JP) 2006-202790
Jul. 26, 2006 (JP) 2006-202792

(51) Int. Cl. G03G 15/08

(52) U.S. Cl. 399/284

(57) ABSTRACT

A toner regulating roller that is characterized by having an elastic force of 1.8 N or less,

a developing apparatus that is characterized by allowing the toner regulating roller to be made in press-contact with a developing roller with a linear pressure in the range of 5 to 30 N/m, and

a developing method using the toner regulating roller or the developing apparatus.

This application is based on application(s) No. 2006-202790 and No. 2006-202792 filed in Japan, the contents of which are hereby incorporated by reference.

### BACKGROUND OF THE INVENTION

1. Field of the Invention

The present invention relates to a developing apparatus that is incorporated in an image-forming apparatus such as a copying machine, a printer and a facsimile to be used therein, and also concerns a toner regulating roller that is incorporated and used in the developing apparatus.

2. Description of the Related Art

In an image-forming apparatus such as a copying machine, a printer and a facsimile, a developing apparatus, which develops an electrostatic latent image formed on an electrostatic latent image supporting member, such as an electrophotographic photosensitive member and an electrostatic recording dielectric member, to form a visible toner image, has been used.

With respect to the developing apparatus of this type, for example, those having a structure in which a toner regulating roller is made in press-contact with a developing roller that is placed close to or in contact with an electrostatic latent image supporting member have been known. In the developing apparatus, toner is friction-charged while being formed into a thin toner-layer on the developing roller by the toner regulating roller, and is then transported to a developing area that faces the electrostatic latent image supporting member by the developing roller so that the toner is supplied to the developing process of the electrostatic latent image. In general, the toner regulating roller has a hard roller structure made of materials, such as a metal material and a hard resin material, and even when its surface portion is made of a foamed material or an elastic layer that is softer than the hard roller structure, the elastic force on the surface was 2 N or more (Japanese Patent Application Laid-Open No. 2001-51503, Japanese Patent Application Laid-Open No. Hei 9-258552, Japanese Patent Application Laid-Open No. 2004-29357 and Japanese Patent Application Laid-Open No. 2004-85623). In general, the developing roller also has a hard roller structure made of materials such as a metal material and a hard resin material, and the elastic force of the surface was 2 N or more.

Since the toner regulating roller and the developing roller generally cause dimension errors in the distance from the axis to the surface in each roller and bending in the axis, it has been an inevitable problem for the distance between the toner regulating roller surface and the developing roller surface to locally vary due to the rotation. For this reason, one of rollers, which has a comparatively hard surface, is pushed onto the other roller having a comparatively soft surface, and these rollers are thus maintained to be made in contact with each other. In the case when, for example, a toner regulating roller having a diameter of about 12 mm with a foamed polyurethane layer having a surface elastic force of about 5 N and a developing roller having a diameter of about 16 mm with a silicon rubber layer having a surface elastic force of about 30 N are used, the developing roller is attached in a manner so as to be pushed into the toner regulating roller by about 0.25 mm. As a result, the contact pressure between these rollers becomes comparatively high so that the toner regulating roller and the developing roller are made in press-contact with each other with a high linear pressure of, for example, about 50 to 150 N/m.

In such a conventional developing apparatus, however, there is a problem of toner deterioration. In other words, toner to which external additives have been added is subjected to a comparatively great stress between the toner regulating roller and the developing roller, with the result that toner degradation in which, for example, the external additives, in particular, those having a comparatively small particle size, are buried into a toner particle tends to occur. When external additives are buried, fluidizing property is reduced, resulting in that the toner transporting amount of the developing roller tends to become unstable during endurance operations, and that the toner chargeability is lowered to cause fogging in the resulting image.

### DISCLOSURE OF THE INVENTION

[Problems to be Solved by the Invention]

In order to solve these problems, an attempt is made to reduce the contacting pressure between the toner regulating roller and the developing roller; however, when the contacting pressure is reduced, with the conventional toner regulating roller being used, the toner transporting amount of the developing roller becomes unstable from the initial stage, resulting in degradation in charging stability.

### BRIEF SUMMARY OF THE INVENTION

The objective of the present invention is to provide a developing apparatus and a toner regulating roller that can achieve a stable chargeability while preventing the toner degradation, so that high-quality images can be obtained for a long period.

[Means to Solve the Problems]

The present invention relates to a developing apparatus that is characterized by allowing a toner regulating roller having an elastic force of 1.8 N or less to be made in press-contact with a developing roller with a linear pressure in the range of 5 to 30 N/m.

The present invention also relates to a toner regulating roller that is characterized by having an elastic force of 1.8 N or less.

### BRIEF DESCRIPTION OF THE DRAWINGS

FIG. 1 is a schematic cross-sectional block diagram that shows one example of a developing apparatus in accordance with the present invention.

FIG. 2 is a schematic cross-sectional view perpendicular to the axis direction of a linear pressure measuring device.

FIGS. 3(A) and 3(B) are schematic drawings that explain the push-in amount of a regulating roller.

FIG. 4(A) is a schematic drawing that shows a bias to be applied to a developing roller upon evaluation in Examples; and FIGS. 4(B) to 4(E) are schematic drawings each of which shows a bias to be applied to a regulating roller upon evaluation in Examples.

### DETAILED DESCRIPTION OF THE INVENTION

The present invention relates to a developing apparatus that is characterized by allowing a toner regulating roller having an elastic force of 1.8 N or less to be made in press-contact with a developing roller with a linear pressure in the range of 5 to 30 N/m.

The present invention also relates to a toner regulating roller that is characterized by having an elastic force of 1.8 N or less.

In accordance with the present invention, since it is possible to effectively achieve a smaller linear pressure between the toner regulating roller and the developing roller, the toner degradation such as buried external additives can be reduced and it becomes possible to achieve stable transporting amount and chargeability. Consequently, the toner charging stability can be improved so that high-quality images can be obtained for a long period.

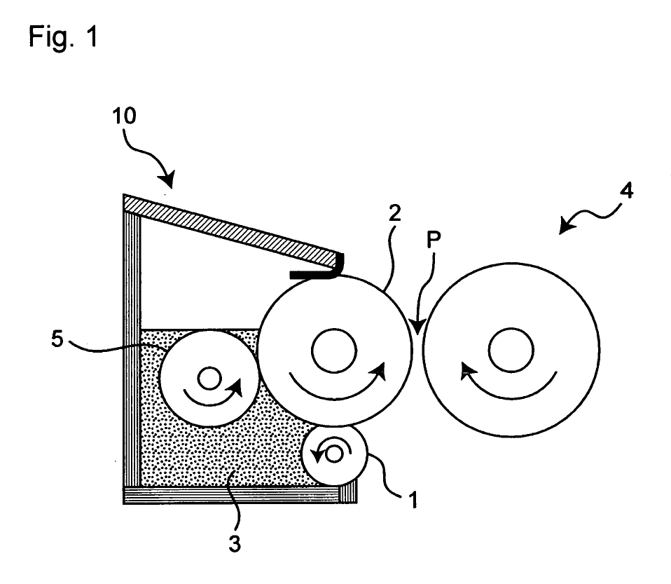

The developing apparatus of the present invention has a structure in which a specific toner regulating roller (hereinafter, referred to simply as “regulating roller”) is made in press-contact with a developing roller. For example, as shown in FIG. 1, a regulating roller 1 is made in press-contact with a developing roller 2 on the upstream side of a developing area P in the rotation direction of the developing roller 2; thus, a thin layer of toner 3 is formed on the surface of the developing roller 2, and is also friction-charged. After the thin toner-layer has been friction-charged on the surface of the developing roller 2 in the developing apparatus 10, the thin toner-layer is transported to the developing area P that faces an electrostatic latent image supporting member 4 by the developing roller 2 so as to be supplied to the developing process of the electrostatic latent image. In FIG. 1, the reference numeral 5 represents a toner supply roller that is used for supplying toner to the developing roller 2, and is placed on the upstream side of the regulating roller 1 in the rotation direction of the developing roller 2; however, this is not necessarily required to be installed.

The regulating roller, which has a surface elastic force of 1.8 N or less, in particular, in the range of 0.1 to 1.8 N, preferably in the range of 0.5 to 1.6 N, is deformed by an external force; however, the shape is restored by removing the external force. By using the regulating roller having such an elastic force, the linear pressure between the regulating roller and the developing roller can be effectively reduced to a range, which will be described later, so that stable transporting amount and chargeability can be achieved, while toner degradation is prevented. Moreover, the toner degradation, such as coming off the large-size external additive agent, can be prevented so that the cleaning property of the electrostatic latent image supporting member can be achieved. Furthermore, the toner chargeability can be stabilized. As a result, it becomes possible to obtain high-quality images for a long time. When a regulating roller having an excessive elastic force is used, the linear pressure between the regulating roller and the developing roller becomes too high to be set within the range, which will be described later, with the result that the amount of toner transportation by the developing roller during endurance operations becomes unstable and the toner chargeability is lowered. Moreover, during endurance operations, the cleaning property is lowered and the chargeability of the thin toner-layer on the developing roller becomes unstable.

The elastic force is one scale indicating hardness, and the smaller the value, the softer the corresponding material.

In the present specification, the elastic force is indicated by a value measured by the following method: In other words, a roller is placed on a measuring base, and a plastic disc having a diameter of 13 mm is attached to a pushpull gauge (ZP-20, made by IMADA Co., Ltd.); thus, the value obtained when this is pressed perpendicularly onto the center axis of the roller is defined as an elastic force (N). The amount of push-in at this time is set to 1.0 mm, and the value obtained after a lapse of 1 minute is used as a measured value.

The amount of push-in refers to a maximum amount of deformation (distance) in the radial direction of the regulating roller, when the surface of the regulating roller is deformed into a concave shape due to contact of the regulating roller with another member.

The regulating roller having such an elastic force is easily obtainable upon request to a roller manufacturing firm. It is well known to the roller manufacturing firms that, for example, the roller surface is made of a foamed material so that the roller elastic force can be controlled by adjusting the hardness of the foamed material; therefore, by properly adjusting the amount of a foaming agent upon manufacturing the foamed material, the elastic force of the regulating roller can be controlled. When the amount of the foaming agent is increased, the hardness of the resulting foamed material is lowered so that the elastic force of the roller obtained by using the corresponding foamed material becomes smaller. In contrast, when the amount of the foaming agent is reduced, the hardness of the resulting foamed material is increased so that the elastic force of the roller obtained by using the corresponding foamed material becomes greater.

In the case when, for example, a regulating roller having a structure in which a foamed layer, made of a polyurethane foamed material, is formed on the peripheral face of a core metal is manufactured, specifically, first, a polyol component, a polyisocyanate component and a foaming agent, as well as additives such as a conductivity-applying agent and a foam-adjusting agent, if necessary, are mixed at predetermined ratios and stirred by a mixer. After having been discharged and foamed, the resulting mixture is cured by applying heat. Thereafter, a hole to which a core metal is inserted is formed in the foamed material, and the core metal on the peripheral surface of which a bonding agent is applied is inserted into the hole. After the foamed material and the core metal have been sufficiently bonded to each other, the foamed material is machined and shape-formed so that a foamed layer having a uniform thickness is formed. After the formation of the foamed layer, normally, the foamed layer is covered with a cylindrical tube made of conductive polyamide or the like, and by bonding the foamed layer to the end portion of the tube through a conductive bonding agent so that a skin layer having a thickness of 50 to 300 μm is formed on the surface of the foamed layer. In the case of placing the skin layer on the surface of the foamed layer, an elastic force, measured on the skin layer, is set in the above-mentioned range. Although not particularly limited as long as the above-mentioned elastic force can be achieved, the thickness of the foamed layer is normally set in the range from 2 to 10 mm, particularly from 2 to 7.5 mm. The diameter of the core metal is normally set in the range from 3 to 10 mm.

The density and the average size of pores of the foamed layer constituting the regulating roller are not particularly limited as long as the above-mentioned elastic force is achieved, and are normally set in the following ranges:

Foamed Layer:

density from 10 to 80 kg/m³, particularly from 15 to 60 kg/m³;

Average Pore Size:

from 0.2 to 1.5 mm, particularly from 0.3 to 1.2 mm

The density is measured based on JIS K 6400.

With respect to the average pore size, the pore size of each of pores is measured by using an electron microscope (SEM), and the value obtained by averaging pore sizes of 100 pores is used.

It is preferable that the regulating roller has conductivity, and normally it has the following volume resistivity.

Regulating Roller Containing the Core Metal:

volume resistivity: 10² to 10⁸Ω, particularly 10⁴ to 10⁶Ω

The volume resistivity was measured through processes in which: a roller to be measured was placed on a copper plate also functioning as an electrode, with a load of 500 g being applied to each of the two ends of the core metal, and the current value was measured upon application of a DC voltage of 100 V across the core metal and the copper plate so that the resistivity was found based upon resistivity (Ω)=100 (V)/current (A). The measurements were carried out four times with the contact portion to the copper plate being changed by about 90 degrees, and the average value was defined as the resistance value of the roller.

The regulating roller is made in press-contact with the developing roller so that the linear pressure is set in the range from 5 to 30 N/m, preferably from 7 to 28 N/m, more preferably from 10 to 15 N/m. When the linear pressure is too low, the toner transporting amount of the developing roller becomes unstable from the initial stage and the toner chargeability is lowered, although the toner degradation can be prevented. When the linear pressure is too high, the toner transporting amount of the developing roller becomes unstable during endurance operations, and the toner chargeability is lowered. During endurance operations, the cleaning property is lowered, and the toner chargeability becomes unstable. Here, strictly speaking, the linear pressure is not necessarily constant in the axis direction due to dimensional errors of the roller, bending of the roller axis and the like; therefore, in the present invention, it is only necessary to achieve the above-mentioned linear pressure at the center portion in the axis direction in the standstill state.

The push-in amount of the regulating roller by the developing roller is normally set in the range from 0.25 to 1.5 mm, preferably from 0.40 to 1.2 mm, more preferably from 0.50 to 1.0 mm. Therefore, it is only necessary to achieve the above-mentioned linear pressure when the push-in amount is set at any value within the above-mentioned range. When the push-in amount is too small, it is not possible to ensure the contact between the regulating roller and the developing roller upon driving due to the dimensional errors of the roller and the bending of the axis, with the result that the thin toner-layer is not formed. When the push-in amount is too large, the toner degradation tends to occur easily, with the result that the toner transporting amount of the developing roller becomes unstable during endurance operations and the toner chargeability is lowered. During endurance operations, the cleaning property is lowered, and the toner chargeability of the thin toner-layer on the developing roller becomes unstable. Strictly speaking, the push-in amount of the regulating roller is not necessarily constant in the axis direction due to dimensional errors of the roller, bending of the axis and the like; therefore, in the present invention, it is only necessary to achieve the above-mentioned push-in amount at the center portion in the axis direction in the standstill state.

The linear pressure between the regulating roller and the developing roller can be measured through the following method by using a linear pressure measuring device.

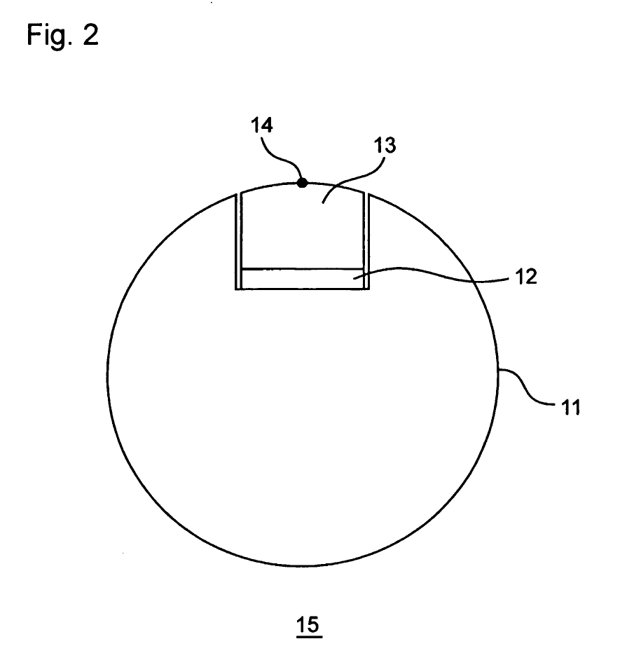

As indicated by a schematic cross-sectional view of FIG. 2, a linear pressure measuring device 15 has a structure in which a load converter (9E01-L43-10N; made by NEC San-ei Instruments, Ltd.) 12 is incorporated into an aluminum roller 11 having a diameter of 16 mm. More specifically, a pressure-receiving member 13 extending in the length direction (axis direction) is placed on the roller surface of the present measuring device, and when a pressure is applied to this pressure-receiving member, the applied load is measured by the load converter 12 incorporated therein. The linear pressure is found based upon this measured value and the distance of the pressurized portion in the roller length direction in the pressure-receiving member 13.

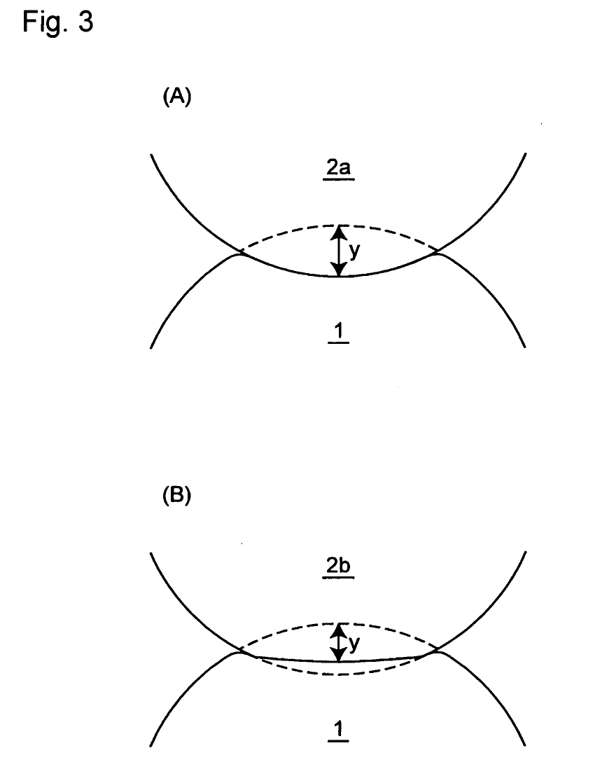

More specifically, first, the push-in amount of the regulating roller, caused by the press-contact between the developing roller and the regulating roller, is measured. For example, in the case when, as shown in FIG. 3(A), a developing roller 2a is so hard that it is not deformed by the press-contact to a regulating roller 1, the push-in amount of the regulating roller 1 is indicated by y in FIG. 3(A). For example, in the case when, as shown in FIG. 3(B), a developing roller 2b is so soft that it is deformed by the press-contact thereto, the push-in amount of the regulating roller 1 is indicated by y in FIG. 3(B).

The measured push-in amount y of the regulating roller is reproduced by the linear pressure measuring device and the regulating roller. With the axis of the regulating roller and the axis of the linear pressure measuring device being maintained in parallel with each other, the surface center 14 of the pressure-receiving member 13 of the linear pressure measuring device is made in press-contact with the regulating roller and pushed therein to achieve the above-mentioned push-in amount y. The linear pressure is found based upon the measured value (load) of the linear pressure measuring device and the distance in the length direction of the roller at the contact portion between the measuring device and the regulating roller.

In FIG. 1, the rotation direction of the regulating roller 1 is a counter (reverse) direction with respect to the developing roller at the contact portion to the developing roller 2; however, not limited to this arrangement, for example, the rotation direction may be a with (same) direction, or it may be attached in the stopped state without being rotated. From the viewpoint of further improving the toner chargeability, the regulating roller is preferably rotated in the counter direction. The rotation direction of the regulating roller corresponds to the rotation direction at the contact portion to the developing roller, and is indicated based upon the rotation direction of the developing roller.

In the case when the regulating roller 1 is allowed to rotate, in particular, in the counter direction, the peripheral velocity ratio (regulating roller/developing roller) between the regulating roller and the developing roller is preferably set to 3.00 or less, preferably from 0.20 to 1.5, from the viewpoint of further improving the toner chargeability.

In the case when, for example, the cross-sectional diameter of the regulating roller is set to 10 to 15 mm, the peripheral velocity of the regulating roller 1 is normally set to 0 to 90 m/min, in particular to 0 to 30 m/min.

With respect to the developing roller 2 of the present invention, not particularly limited, those conventionally used in the field of developing apparatuses may be used. For example, it may have a metal roller structure constituted only by a core metal such as aluminum and stainless steel, or may have an elastic roller structure in which a rubber layer made of silicone rubber or the like is formed on the outer circumferential face of such a core metal, or may have a composite roller structure in which a coating layer made of acrylonitrile-butadiene rubber or the like is formed on the outer circumferential face of such a structure. The coating layer may have a single-layer structure, or may have a multi-layer structure of two or more layers, and preferably, it has a two-layer structure constituted by an intermediate layer and a surface layer.

In any of the structures of the developing roller, the surface roughness of the outermost surface is preferably set in the range from 0.1 to 10 μm, from the viewpoint of further stabilizing the toner transporting amount. In the case of the metal roller structure, the surface roughness is adjusted by subjecting the outermost surface to a blasting treatment. In the case of the elastic roller structure, the surface roughness is prepared by allowing the rubber layer to contain fine particles such as silica. In the case of the composite roller structure, the surface roughness is prepared by allowing the coating layers, in particular, the intermediate layer and the surface layer, to contain fine particles such as silica.

From the viewpoint of further improving the toner chargeability, the developing roller is preferably allowed to have conductivity. Its volume resistivity is preferably set to 10² to 10⁸Ω, particularly, to 10⁴ to 10⁶Ω. In particular, in the case when the developing roller has the elastic roller structure or the composite roller structure, the above-mentioned volume resistivity is achieved by allowing the rubber layer and the coating layer to contain a conductivity-applying agent such as carbon black.

Normally, a DC voltage is applied to each of the developing roller and regulating roller. From the viewpoint of further improving the toner chargeability, based upon the DC voltage applied to the developing roller, a DC voltage on the same polarity side as the polarity to which the toner is charged is preferably applied to the regulating roller.

For example, when the toner is charged to negative polarity, a DC voltage, located further on the negative side as compared with the DC voltage to be applied to the developing roller, is applied to the regulating roller. In other words, a DC voltage that is lower than the DC voltage to be applied to the developing roller is applied to the regulating roller.

For example, when the toner is charged to the positive polarity, a DC voltage, located further on the positive side as compared with the DC voltage to be applied to the developing roller, is applied to the regulating roller. In other words, a DC voltage that is higher than the DC voltage to be applied to the developing roller is applied to the regulating roller.

The polarity to which toner is charged refers to the positive or negative polarity that the toner has upon developing, and the polarity is confirmed by measuring quantity of charge of the toner on the developing roller in the developing area.

With respect to the potential difference between the DC voltage to be applied to the developing roller and the DC voltage to be applied to the regulating roller, not particularly limited as long as the objective of the present invention is achieved, it is normally set to 5 to 400 V, more preferably to 50 to 300 V, in the absolute value.

The DC voltage to be applied to the developing roller is normally set to −100 to −550 V, particularly to −250 to −450 V, in the case when the toner is charged to negative polarity, and it is normally set to 100 to 550 V, particularly to 250 to 450 V, in the case when the toner is charged to positive polarity.

It is preferable that an AC voltage is superposed on the developing roller together with the DC voltage. With respect to the AC voltage to be applied to the developing roller, not particularly limited, for example, an AC voltage having a peak-to-peak value (Vpp: amplitude) of 800 to 3000 V, in particular, 1000 to 2500 V, a frequency of 1 to 5 kHz, in particular, 2 to 4 kHz, and a duty ratio of 10 to 80%, in particular, 20 to 60%, is preferably used. With respect to the waveform of the AC voltage to be applied to the developing roller, those of various kinds, such as a rectangular waveform, a sine waveform and a saw-shaped waveform, may be used, and the rectangular waveform is preferably used.

In the same manner, it is preferable that an AC voltage is superposed on the regulating roller together with the DC voltage. With respect to the AC voltage to be applied to the regulating roller, not particularly limited, for example, an AC voltage having a peak-to-peak value (Vpp: amplitude) of 800 to 3200 V, in particular, 1000 to 2700 V, a frequency of 1 to 5 kHz, in particular, 2 to 4 kHz, and a duty ratio of 10 to 80%, in particular, 20 to 60%, is preferably used. With respect to the waveform of the AC voltage to be applied to the regulating roller, those of various kinds, such as a rectangular waveform, a sine waveform and a saw-shaped waveform, may be used, and the rectangular waveform is preferably used.

With respect to the toner 3, a conventionally-known toner generally used, to which external additives are added, may be used, and, for example, a toner prepared by adding external additives to toner particles formed by allowing a binder resin to contain a colorant, a charge-controlling agent, a release agent and the like, if necessary, may be used. In the present invention, in order to further improve toner chargeability, a toner that is negatively chargeable is preferably used. The charging polarity of the toner can be easily controlled based upon the kind of a charge-controlling agent, the kind of external additive and the amount thereof.

With respect to the external additives, conventionally-known additives generally used in the field of electrostatic latent image developing toners may be used. Examples thereof include: inorganic fine particles, such as silica, titanium oxide, aluminum oxide and strontium titanate and organic fine particles, such as acrylic resin, styrene resin, silicone resin and fluororesin. In particular, those materials that have been hydrophobicized by a silane coupling agent, a titanium coupling agent, silicone oil or the like are preferably used.

With respect to the external additive, at least those particles with a small particle size having an average primary particle size in the range from 1 nm or more to less than 150 nm, in particular, from 5 nm to 100 nm, are used, and, preferably together with the small-size external additive, those particles with a large particle size having an average primary particle size in the range from 150 nm to 450 nm, in particular, from 150 nm to 400 nm, are used in combination. When the particle size of the large-size external additive is too large or too small, the function for cleaning residual toner on the electrostatic latent image supporting member is lowered to cause the subsequent line-like unevenness on an image. The amount of addition of the small-size external additive is normally set in the range from 0.1 to 3 parts by weight, in particular, from 0.5 to 2.5 parts by weight, with respect to 100 parts by weight of toner particles, and in the case when two kinds or more of these are used, the total amount thereof is preferably set in the above-mentioned range. The amount of addition of the large-size external additive is normally set in the range from 0.5 to 3 parts by weight, in particular, from 1 to 3 parts by weight, with respect to 100 parts by weight of toner particles, and in the case when two kinds or more of these are used, the total amount thereof is preferably set in the above-mentioned range.

With respect to the binder resin, although not particularly limited, examples thereof include polystyrenic resins (in particular, styrene-acrylate-based resins), polyester resins, epoxy-based resins, vinyl chloride resin, phenol resin, polyethylene resin, polypropylene resin, polyurethane resin and silicone resin or the like.

With respect to the colorant, various conventionally-known pigments and dyes generally used in the field of electrostatic latent image developing toners may be used. Examples thereof include: carbon black, aniline black, activated carbon, magnetite, Benzine Yellow, Permanent Yellow, Naphthol Yellow, Phthalocyanine Blue, Fast Sky Blue, Ultramarine Blue, Rose Bengal and Lake Red.

With respect to the charge-controlling agent, various conventionally-known agents in the field of electrostatic image developing toners may be used. With respect to the charge-controlling agent for use in the positively chargeable toner, examples thereof include: Nigrosine-based dyes, quaternary ammonium salt-based compounds, triphenyl methane-based compounds, imidazole-based compounds and polyamine resin. With respect to the charge-controlling agent for use in the negatively chargeable toner, examples thereof include: azo-based dyes containing metal such as Cr, Co, Al and Fe, salicylic acid metal compounds, alkyl salicylic acid metal compounds and calix arene compounds.

With respect to the release agent, various conventionally-known agents in the field of electrostatic image developing toners may be used. Examples thereof include: polyethylene, polypropylene, carnauba wax, sazol wax and ester-based wax or the like, and each of these may be used alone, or two or more kinds of these may be used in combination.

The toner particles can be made through various manufacturing methods such as a so-called pulverizing method, a suspension polymerization method, an emulsion polymerization method, an emulsion polymerization aggregation method in which resin fine particles, obtained through an emulsion-polymerization method, are aggregated and fused together with colorant particles to provide toner particles, and an emulsion-dispersing method.

### EXAMPLES

In the following description, the term “parts” refers to “parts by weight”.

<Production of toner particles WC1>

(Production of Resin fine Particles)

To a separable flask (5000 ml) equipped with a stirring device, a temperature sensor, a condenser and a nitrogen introducing device was loaded a solution preliminarily prepared by dissolving 7.08 g of an anionic active agent (sodium dodecylbenzene sulfonate: SDS) in ion exchanged water (2760 g). This was heated to 80° C. in the flask, while being stirred at the stirring speed of 230 rpm under a nitrogen gas flow. On the other hand, to a monomer composed of 115.1 g of styrene, 42.0 g of n-butyl acrylate and 10.9 g of methacrylic acid was added 72.0 g of the following compound: CH₃(CH₂)₂₀COOCH₂C(CH₂OCO(CH₂)₂OCH₃)₃, and this was heated to 80° C. so as to be dissolved; thus, a monomer solution was prepared.

The above-mentioned heated solutions were mixed and dispersed by using a mechanical dispersing machine with a circulating path so that emulsified particles having a uniform dispersed particle size were prepared. To this was added a solution prepared by dissolving 0.90 g of a polymerization initiator (potassium persulfate: KPS) in 200 g of ion exchanged water, and this was heated at 80° C. for 3 hours, and stirred so that latex particles were formed. To this was successively added a solution prepared by dissolving 8.00 g of the polymerization initiator (KPS) in 240 ml of ion exchanged water, and after a lapse of 15 minutes, to this was dropped a mixed solution of styrene (383.6 g), n-butyl acrylate (140.0 g), methacrylic acid (36.4 g) and t-dodecyl mercaptan (13.7 g) at 80° C. in 120 minutes. After the dropping process, this was heated and stirred for 60 minutes, and then cooled to 40° C. so that resin fine particles containing ester wax were obtained.

(Production of Toner Particles)

To 160 ml of ion exchanged water was dissolved 10 g of sodium n-dodecyl sulfate through a stirring process. To this solution was gradually added 20 g of C. I. Pigment Blue 15-3 (cyan pigment) while being stirred, and this was dispersed by using a Clearmix. This dispersion solution was used as a cyan colorant dispersion solution. To a four-neck flask of 5 L equipped with a temperature sensor, a condenser, a nitrogen introducing device, and a stirring device was loaded the above-mentioned resin fine particles (1250 g), ion exchanged water (2000 ml) and the colorant dispersion solution to be stirred therein. After having been adjusted to 30° C., an aqueous solution of sodium hydroxide of 5 mols/liter was added to this solution so that pH was adjusted to 10.0. To this was added an aqueous solution prepared by dissolving 52.6 g of magnesium chloride hexahydrate in 72 ml of ion exchanged water at 30° C. in 5 minutes, while being stirred. After this was left standing still for one minute, a temperature-raising process is started so that the solution temperature was raised to 90° C. in 6 minutes (temperature-raising speed=10° C./minute). In this state, the particle size was measured by a Coulter Counter TA-II so that at the time when the volume-average particle size reached 6.5 μm, an aqueous solution, prepared by dissolving 115 g of sodium chloride in 700 ml of ion exchanged water, was added to this to stop the growth of particles, and successively, this was further heated and stirred for 6 hours at a solution temperature of 90° C.±2° C. to be salted-out/fusion-adhered. Thereafter, this was cooled to 30° C. under conditions of 6° C./min, and hydrochloric acid was added thereto to adjust pH to 2.0, and the stirring process was then stopped. The resulting colored particles were filtrated, and repeatedly washed with ion exchanged water, and then dried by a hot air flow at 40° C.; thus, toner particles WC1 having a volume-average particle size of 6.5 μm and an average degree of roundness of 0.975 were obtained.

<Production of Toner Particles DC1>

(Production of Polyester Resin A)

To a four-necked glass flask were loaded 4.0 mols of polyoxypropylene (2,2)-2,2-bis(4-hydroxyphenyl)propane (hereinafter, referred to as “PO”), 6.0 mols of polyoxyethylene (2,0)-2,2-bis(4-hydroxyphenyl)propane (hereinafter, referred to as “EO”), 9.0 mols of terephthalic acid (hereinafter, referred to as “TPA”) and dibutyl tin oxide serving as a catalyst, and to this were attached a thermometer, a stainless stirring stick, a dropping-type condenser and a nitrogen gas directing tube, and this was allowed to react, while being stirred and heated under a nitrogen gas flow in a mantle heater. The progress of this reaction was traced by measuring an acid value. At the time when a predetermined acid value was reached, the respective reactions were finished, and the resulting product was cooled to room temperature so that polyester resin A was obtained. The physical properties of polyester resin A are shown below: Number average molecular weight (Mn): 3,300, Weight average molecular weight (Mw)/number average molecular weight (Mn): 4.2, Glass transition temperature (Tg): 68.5° C., Softening point (TM): 110.3° C., Acid value: 3.3 mg KOH/g, OH value: 28.1 mg KOH/g.

(Production of Pigment Master Batch)

Polyester resin A and C.I. Pigment Blue 15-3 were loaded into a pressure kneader at a weight ratio of 7:3, and kneaded for 1 hour at 120° C. After having been cooled, this was coarsely pulverized with a hammer mill to prepare a pigment master batch having a pigment content of 30 wt %.

(Production of Toner Particles)

After 100 parts of polyester resin A, 15 parts of the pigment master batch, 2.0 parts of a zinc complex (E-84, made by Orient Kagaku Kogyo K.K.) of salicylic acid serving as a charge-controlling agent and 2 parts of an oxide-type low-molecular-weight polypropyrene (100TS, made by Sanyo Chemical Industries, Ltd. : softening point 140° C., acid value 3.5) were sufficiently mixed by a Henschel mixer, the resulting mixture was melt and kneaded by using a twin-screw extruder kneader (PCM-30, made by Ikegai Corporation) from which a discharging unit was removed, and the resulting knead matter was rolled to have a thickness of 2 mm by using a cooling press roller, and after having been cooled by a cooling belt, it was coarsely pulverized by using a feather mill. Thereafter, the resulting matter was pulverized by using a mechanical grinding device (KTM: made by Kawasaki Heavy Industries, Ltd.) to an average particle size of 10 to 12 μm, and further ground and coarsely classified by a jet mill (IDS: made by Nippon Pneumatic MFG.) to an average particle size of 6.8 μm, and then classified into fine particles by a rotor-type classifier (Teeplex-type classifier 100ATP: made by Hosokawa Micron K.K.) to obtain toner particles DC1 having a volume-average particle size of 6.5 μm and an average degree of roundness of 0.943.

<Production of Toner>

Each of the toner particles and each of the external additives listed in the Table were mixed by using a Henschel mixer of 9 L (FM10B: made by Mitsui Miike Chemical Industries, Co., Ltd.) to obtain a toner. With respect to the Henschel mixer, an ST blade was used as an upper blade and an AO blade was used as a lower blade. Each of the toners exhibited negative chargeability.

TABLE 1

| | | External additives (amount of addition (parts by weight)*) | | | | | | |
|---|---|---|---|---|---|---|---|---|
| | | External | External | External | External | External | External | External |
| | | additive1 | additive2 | additive3 | additive4 | additive5 | additive6 | additive7 |
| | Toner | (particle | (particle | (particle | (particle | (particle | (particle | (particle |
| | particles | size 7 nm) | size 30 nm) | size 100 nm) | size 150 nm) | size 300 nm) | size 400 nm) | size 50 nm) |
| Toner 1 | WC1 | 1.1 | 0.7 | 2.0 | 0 | 0 | 0 | 0 |
| Toner 2 | WC1 | 1.1 | 0.7 | 0 | 2.0 | 0 | 0 | 0 |
| Toner 3 | WC1 | 1.1 | 0.7 | 0 | 0 | 2.0 | 0 | 0 |
| Toner 4 | WC1 | 1.1 | 0.7 | 0 | 0 | 0 | 2.0 | 0 |
| Toner 5 | WC1 | 1.1 | 0.7 | 0 | 0 | 0 | 0 | 2.0 |
| Toner 6 | DC1 | 1.1 | 0.7 | 2.0 | 0 | 0 | 0 | 0 |
| Toner 7 | DC1 | 1.1 | 0.7 | 0 | 2.0 | 0 | 0 | 0 |
| Toner 8 | DC1 | 1.1 | 0.7 | 0 | 0 | 2.0 | 0 | 0 |
| Toner 9 | DC1 | 1.1 | 0.7 | 0 | 0 | 0 | 2.0 | 0 |
| Toner | DC1 | 1.1 | 0.7 | 0 | 0 | 0 | 0 | 2.0 |
| 10 | | | | | | | | |

*The amount of addition is a value relative to 100 parts by weight of toner particles.

External additive 1: Hydrophobic silica having an average primary particle size of 7 nm (TS; made by Cabot Corporation)
External additive 2: Hydrophobic silica having an average primary particle size of 30 nm obtained by subjecting silica (90G; made by Nippon Aerosil Co., Ltd.) to a surface treatment by using hexamethyldisilazane
External additive 3: Strontium titanate having an average primary particle size of 100 nm (made by Titan Kogyo K.K.)
External additive 4: Strontium titanate having an average primary particle size of 150 nm (made by Titan Kogyo K.K.)
External additive 5: Strontium titanate having an average primary particle size of 300 nm (made by Titan Kogyo K.K.)
External additive 6: Strontium titanate having an average primary particle size of 400 nm (made by Titan Kogyo K.K.)
External additive 7: Strontium titanate having an average primary particle size of 500 nm (made by Titan Kogyo K.K.)

<Production of Regulating Roller>

A foamed layer was formed on the outer circumferential face of a core metal having a cylindrical shape, and the outer circumferential face was further covered with a tube to form a skin layer so that a regulating roller was prepared.
Core metal: SUS with a diameter of 5 mm
Low-hardness foamed layer: foamed urethane having a thickness of 3.5 mm
Skin layer: conductive polyamide (Nylon 6) having a film thickness of 100 μm

More specifically, a hole through which a core metal is inserted was formed in a foamed material serving a material to form a foamed layer, and the core metal, coated with a hot-melt bonding agent on its outer circumferential face, was inserted into the hole. This was heated so that the foamed material and the core metal were bonded to each other through the hot-melt bonding agent. After having been sufficiently bonded to each other, the foamed material was machined and shape-formed into a foamed layer having a uniform thickness. Thereafter, the foamed layer was covered with a cylindrical tube that was preliminarily prepared to have a predetermined length, and the foamed layer and the end portions of the tube were bonded to each other by using a conductive bonding agent so that a regulating roller having a diameter of 12 mm was manufactured.

By selecting the foamed material forming the foamed layer, regulating rollers 1 to 4 having different elastic forces were obtained. The elastic force was adjusted by properly adjusting the amount of a foamed agent upon manufacturing each of the foamed materials.

The elastic force of each of the regulating rollers 1 to 4 is shown below:
Regulating roller 1: 0.8 N (density 21 kg/m³, average pore size: 1300 μm)
Regulating roller 2: 1.6 N (density 40 kg/m³, average pore size: 900 μm)
Regulating roller 3: 1.8 N (density 52 kg/m³, average pore size: 800 μm)
Regulating roller 4: 2.2 N (density 62 kg/m³, average pore size: 500 μm)

The density and average pore size in the above-mentioned parentheses are those of a foamed material used upon manufacturing each of the regulating rollers.

### Experimental Example A

The relationship between the push-in amount and the linear pressure in each of the regulating rollers 1 to 4 was measured. The pressure-receiving member 13 of a linear pressure measuring device 15 shown in FIG. 2 was pushed in each of the regulating rollers by a predetermined push-in amount, and the linear pressure at this time was measured.

TABLE 2

| | Regulating roller No. | | | | | | | | | | |
|---|---|---|---|---|---|---|---|---|---|---|---|
| | 1 | 1 | 1 | 1 | 3 | 2 | 2 | 3 | 3 | 3 | 4 |
| Push-in | 0.2 | 0.25 | 0.50 | 0.75 | 0.25 | 0.50 | 0.75 | 0.50 | 0.75 | 1.5 | 0.25 |
| amount | | | | | | | | | | | |
| (mm) | | | | | | | | | | | |
| Linear | 3 | 5 | 8 | 12 | 20 | 25 | 30 | 33 | 40 | 80 | 32 |
| pressure | | | | | | | | | | | |
| (N/m) | | | | | | | | | | | |
| Evaluation | No. 1 | No. 2 | No. 3 | No. 4 | No. 5 | No. 6 | No. 7 | No. 8 | No. 9 | No. 10 | No. 11 |
| Condition | | | | | | | | | | | |
| No. | | | | | | | | | | | |

Respective conditions in which the kind, the push-in amount and the linear pressure of regulating rollers shown in Table 2 were combined are adopted as evaluation conditions, which will be described later.

### Experimental Example B

Evaluation

Charging stability (buried external additive)

A printer (magicolor 2300 DL: made by Konica Minolta Business Technologies, Inc.) was revised so as to incorporate a predetermined regulating roller and carry out an endurance test under predetermined driving and evaluating conditions, and 150 g of toner was charged into the developing apparatus so that endurance driving operations were carried out to produce 5000 printed sheets of A-4 longitudinal white paper (temperature: 23° C., humidity: 65%). After the endurance driving operations, fogging on the photosensitive member as well as on the printed image, caused upon printing an image on a sheet of white paper, was evaluated. With respect to the driving and evaluating conditions, the same conditions as those of the magicolor 2300 DL were used, except that various conditions described in Table 3 were adopted.
⊙: No fogging was observed on any of the photosensitive member and the printed image;
◯: Although Fogging was slightly observed on the photosensitive member, no fogging was observed on the printed image, causing no problem in practical use;
Δ: Although more fogging was observed on the photosensitive member in comparison with the rank “◯”, no fogging was observed on the printed image, causing no problems in practical use; and
×: Fogging was observed not only on the photosensitive member, but also on the printed image, causing problems in practical use.

The result of evaluation obtained when each of various types of toners was used is shown in the following Table. Here, the evaluation condition numbers correspond to those evaluation condition numbers of Table 2.

TABLE 3
Charging stability

| Driving | Bias | −100 V | | | | +100 V | Same | −200 V |
|---|---|---|---|---|---|---|---|---|
| conditions | | | | | | | potential | |
| | Rotation | Stop | Counter | Counter | Counter | Counter | Counter | Counter |
| | direction | | | | | | | |
| | Peripheral | — | 0.25 | 1 | 3 | 0.25 | 0.25 | 0.25 |
| | velocity | | | | | | | |
| | ratio | | | | | | | |
| Evaluation | Toner | Toners | Toners | Toners | Toners | Toners | Toners | Toners |
| conditions | | 3 | 3 | 3 | 3 | 3 | 3 | 3 |
| | | Toners | Toners | Toners | Toners | Toners | Toners | Toners |
| | | 8 | 8 | 8 | 8 | 8 | 8 | 8 |
| | No. 1 | x No thin-film | | — | — | — | — | — |
| | | formation was | | | | | | |
| | | formed. | | | | | | |
| | No. 2 | Δ | ◯ | ◯ | ◯ | Δ | Δ | ◯ |
| | No. 3 | Δ | — | — | — | — | — | — |
| | No. 4 | ◯ | ◯ | ⊙ | ⊙ | ◯ | ◯ | ⊙ |
| | No. 5 | ⊙ | — | — | — | — | — | — |
| | No. 6 | ◯ | — | — | — | — | — | — |
| | No. 7 | Δ | ◯ | ◯ | ◯ | Δ | ◯ | ◯ |
| | No. 8 | X | — | — | — | — | — | — |
| | No. 9 | X | — | — | — | — | — | — |
| | No. 10 | X | — | — | — | — | — | — |
| | No. 11 | X | — | — | — | — | — | — |

In Table 3, the rotation direction refers to the rotation direction of the regulating roller.

The peripheral velocity ratio refers to “peripheral velocity of the regulating roller/peripheral velocity of the developing roller.”

The mark “-” indicates that no evaluation was made.

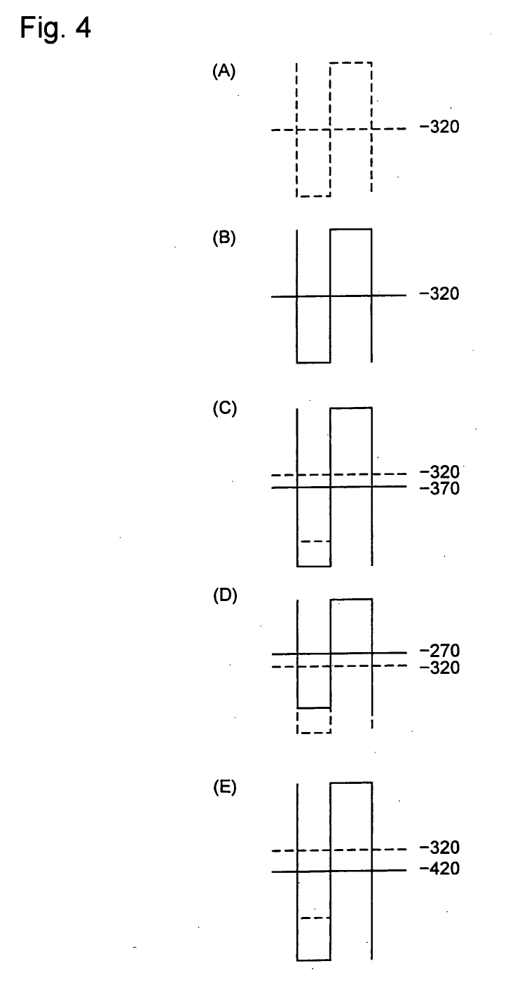

In Table 3, the bias refers to a bias to be applied to the regulating roller, and is indicated based upon a bias, shown in FIG. 4(A), to be applied to the developing roller. Here, the developing roller bias (indicated by dotted line) in FIG. 4(A) has the following factors: DC voltage: −320 V, AC voltage: Vpp 1400 V, frequency: 2 kHz, and duty ratio: 35%.

“Same potential” in the regulating roller bias means that a bias (solid line) shown in FIG. 4(B) is applied. In FIG. 4(B), the developing roller bias (dotted line) shown in FIG. 4(A) is also indicated in a superposed manner, and the regulating roller bias (solid line) and the developing roller bias (dotted line) have the same DC voltage, AC voltage Vpp, frequency and duty ratio.

Here, “−100V” in the regulating roller bias means that the bias (solid line) indicated in FIG. 4(C) is applied. In FIG. 4(C), the developing roller bias (dotted line) shown in FIG. 4(A) is also indicated in a superposed manner, and the regulating roller bias (solid line) and the developing roller bias (dotted line) have the same factors except for DC voltage and AC voltage Vpp.

Moreover, “−100V” in the regulating roller bias means that the bias (solid line) indicated in FIG. 4(D) is applied. In FIG. 4(D), the developing roller bias (dotted line) shown in FIG. 4(A) is also indicated in a superposed manner, and the regulating roller bias (solid line) and the developing roller bias (dotted line) have the same factors except for DC voltage and AC voltage Vpp.

Furthermore, “−200V” in the regulating roller bias means that the bias (solid line) indicated in FIG. 4(E) is applied. In FIG. 4(E), the developing roller bias (dotted line) shown in FIG. 4(A) is also indicated in a superposed manner, and the regulating roller bias (solid line) and the developing roller bias (dotted line) have the same factors except for DC voltage and AC voltage Vpp.

By counter-rotating the regulating roller, or by applying a DC voltage on the same polarity side as the charging polarity of the toner to the regulating roller, it becomes possible to improve the charging stability.

Cleaning Property (Breakaway of External Additive)

A printer (magicolor 2300 DL: made by Konica Minolta Business Technologies, Inc.) was revised so as to incorporate a predetermined regulating roller and carry out an endurance test under predetermined driving and evaluating conditions, and 100 g of toner was charged into the developing apparatus so that endurance driving operations were carried out to produce 5000 printed sheets of A-4 longitudinal white paper (temperature: 23° C., humidity: 65%). After the endurance driving operations, the state of escaped toner on the photosensitive member as well as on a printed image (white paper portion), caused upon printing an image with a solid portion on the upstream side and a blank portion on the downstream side, was evaluated. With respect to the driving and evaluating conditions, the same conditions as those of the magicolor 2300 DL were used, except that various conditions described in Table 4 were adopted. The image with a solid portion on the upstream side and a blank portion on the downstream side refers to an image of A4 paper in which a solid image is placed on half of the paper on the upstream side, with a blank portion (no image) being placed on half of the paper on the downstream side.
⊙: No line-like unevenness was observed on any of the photosensitive member and the printed image;
◯: Although line-like unevenness was slightly observed on the photosensitive member, no line-like unevenness was found on the printed image;
Δ: Although more line-like unevenness was observed on the photosensitive member in comparison with the rank “◯”, no line-like unevenness was found on the printed image, causing no problems in practical use; and
×: Line-like unevenness was observed not only on the photosensitive member, but also on the printed image, causing problems in practical use.

The result of evaluation obtained when each of various types of toners was used is shown in the following Table. The evaluation condition numbers correspond to those evaluation condition numbers of Table 2.

TABLE 4
Cleaning property

| Driving | Bias | −100 V | | | | | −200 V |
|---|---|---|---|---|---|---|---|
| conditions | Rotation | Stop | | | Counter | Counter | Counter |
| | direction | | | | | | |
| | Peripheral | — | | | 0.25 | 1 | 0.25 |
| | velocity | | | | | | |
| | ratio | | | | | | |
| Evaluation | Toner | Toners 1, 6 | Toners 5, | Toners | Toners | Toners | Toners |
| conditions | | | 10 | 2 to 4 | 2 to 4 | 2 to 4 | 2 to 4 |
| | | | | Toners | Toners | Toners | Toners |
| | | | | 7 to 9 | 7 to 9 | 7 to 9 | 7 to 9 |
| | No. 1 | — | — | x No thin-film | | — | — |
| | | | | formation was | | | |
| | | | | formed. | | | |
| | No. 2 | X | X | ⊙ | ⊙ | ⊙ | ⊙ |
| | No. 3 | — | — | ⊙ | — | — | — |
| | No. 4 | X | X | ◯ | ◯ | ◯ | ◯ |
| | No. 5 | — | — | ◯ | — | — | — |
| | No. 6 | — | — | ◯ | — | — | — |
| | No. 7 | — | — | Δ | Δ | Δ | Δ |
| | No. 8 | — | — | X | — | — | — |
| | No. 9 | — | — | X | — | — | — |
| | No. 10 | — | — | X | — | — | — |
| | No. 11 | — | — | X | — | — | — |

In Table 4, the rotation direction, peripheral velocity ratio and bias are respectively the same as those of Table 3.

The mark “-” indicates that no evaluation was made.

<Measuring Method>

(Volume-Average Particle Size)

The particle size was measured by using a Coulter Multisizer II (made by Beckman Coulter, Inc.). The Coulter Multisizer II to which an interface (made by Beckman Coulter, Inc.) used for outputting a particle size distribution and a personal computer were connected was used. With respect to the aperture of the Coulter Multisizer II, that of 50 m was used, and the volume distribution of samples of 0.99 m or more (for example, 2 to 40 μm) was measured so that the particle size distribution and the average particle size were calculated. (Measuring conditions) (1) Aperture: 50 μm (2) Sample preparation method (relating to the toner particle size): To an electrolytic solution (ISOTON-II-pc (made by Beckman Coulter, Inc.) (50 to 100 ml) was added an appropriate amount of surfactant (neutral detergent) and this was then stirred, and to this was further added 10 to 20 mg of a sample to be measured. This system was subjected to a dispersing treatment by using an ultrasonic dispersing machine for one minute so as to be adjusted. (3) Sample preparation method (relating to the particle size of core particles): To 50 to 100 ml of an electrolytic solution (ISOTON-II-pc (made by Beckman Coulter, Inc.) was added an appropriate amount of the associated solution itself to prepare a sample for measurement.

(Average Degree of Roundness of Toner Particles)

The degree of roundness, represented by the following equation, was measured by using a flow-type particle image analyzer (FPIA-1000; made by Toa Iyoudenshi K.K.), and found as an average value of about 10000 toner particles.

Degree of roundness=(Peripheral length of a circle found from a diameter corresponding the circle)/(Peripheral length of a particle projection image)

(Standard Deviation of Degree of Roundness of Toner Particles)

The standard deviation of degree of roundness refers to a standard deviation in the distribution of degree of roundness, and the corresponding value is obtained by the above-mentioned flow-type particle image analyzer simultaneously with the average degree of roundness. As the corresponding value becomes smaller, it is indicated that the toner particle shapes are adjusted more uniformly.

(Softening Point)

The softening point was measured by using by a flow tester (CFT-500: made by Shimadzu Seisakusho K.K.). Here, 1.0 to 1.5 g of resin was precisely weighed, and to this was applied a load of 180 kg/cm² for one minute by using a shape-forming device. This pressure-applied sample was measured by using a flow tester under the following conditions, and the temperature at which ½ of the sample flowed out was defined as a softening point temperature. RATE TEM (temperature-rise rate): 3.0° C./min, SET TEMP: 50.0° C., MAX TEMP: 120.0° C., INTERVAL: 2.0° C., PREHEAT: 2.0° C., LOAD: 30.0 kgf, DIE (DIA): 1.0 mm, DIE (LENG): 1.0 mm, PLUNGER: 1.0 cm². The flow-out starting temperature was set to a temperature at which the sample started to flow out.

(Glass Transition Point)

The glass transition point was measured by using a differential scanning calorimeter (DSC-200: made by Seiko Instruments Inc.). Here, about 10 mg of resin was precisely weighed, and this was put into an aluminum pan, while alumina was put into an aluminum pan so as to be used as reference, and this was heated to 200° C. from normal temperature at a temperature-rise rate of 30° C./min, and this was melt-quenched, and then cooled and subjected to measurements in the range of 20° C. to 150° C. at a temperature-rise rate of 10° C./min. Thus, during this temperature-rise process, the shoulder value of the main heat-absorption peak in the range of 30° C. to 80° C. was defined as a glass transition point.

(Acid Value)

With respect to the acid value, a sample, precisely weighed, was dissolved in an appropriate solvent, and acidic groups of this solution were neutralized by using an indicator such as phenol phthalene; thus, the number (mg) of potassium hydroxide required for the neutralization was used.

(Hydroxide Value)

With respect to the hydroxide value, a sample, precisely weight, was treated by using acetic anhydride, and the resulting acetylated product was hydrolyzed; thus, the number (mg) of potassium hydroxide required for neutralizing isolated acetic acid was used.

(Molecular Weight)

The molecular weight was found by using a gel permeation chromatography (807-IT Type: Nippon Bunko Kogyo K.K.), with tetrahydrofuran being used as a carrier solvent, based upon polystyrene conversion.

What is claimed is:

1. A developing apparatus comprising:
a developer housing unit that houses a developer;
a developer supporting member that transports the developer with the developer being held on a surface thereof; and
a regulating roller that is installed to be made in press-contact with the developer supporting member with a linear load in the range of 5 to 30 N/m, and has a surface elastic force of 1.8 N or less.

2. The developing apparatus according to claim 1, wherein the regulating roller has a foamed layer made of foamed polyurethane.

3. The developing apparatus according to claim 1, wherein the regulating roller has a foamed layer made of a foamed material having a density of 10 to 80 kg/M³ and an average pore size in the range of 0.2 to 1.5 mm.

4. The developing apparatus according to claim 1, wherein the regulating roller has a conductive property, with a volume resistivity being set in the range from 10² to 10⁸Ω.

5. The developing apparatus according to claim 1, wherein the regulating roller has a surface elastic force in the range from 0.1 to 1.8 N.

6. The developing apparatus according to claim 1, wherein the developer supporting member is a developing roller, and the regulating roller is allowed to counter-rotate against the developing roller, with a peripheral velocity ratio (regulating roller/developing roller) between the regulating roller and the developing roller being set to 3.00 or less.

7. The developing apparatus according to claim 6, wherein the peripheral velocity ratio (regulating roller/developing roller) between the regulating roller and the developing roller is in the range from 0.20 to 1.50.

8. The developing apparatus according to claim 1, wherein a voltage on the same polarity side as the polarity with which the developer is charged upon application of a voltage to the developer supporting member is applied to the regulating roller.

9. The developing apparatus according to claim 1, wherein an external additive having an average primary particle size of 150 to 450 nm is externally added to the developer.

10. A regulating roller, which is used so as to be made in press-contact with a developer supporting member in a developing apparatus, and has a surface elastic force of 1.8 N or less.

11. The regulating roller according to 10, comprising a foamed layer made of foamed polyurethane.

12. The regulating roller according to claim 10, comprising a foamed layer made of a foamed material having a density of 10 to 80 kg/m³ and an average pore size in the range of 0.2 to 1.5 mm.

13. The regulating roller according to claim 10, having a conductive property with a volume resistivity being set in the range from 10² to 10⁸Ω.

14. The regulating roller according to claim 10, in which the surface elastic force is in the range from 0.1 to 1.8 N.

15. A developing method, which develops a latent image formed on an electrostatic latent image supporting member in an electrophotographic system, comprising:
forming a thin developer layer on a developer supporting member by allowing a developer to pass through a press-contact portion that is formed by making a regulating roller having a surface elastic force of 1.8 N or less in press-contact with a developer supporting member with a linear load of 5 to 30 N/m;
transporting the developer thin layer formed on the developer supporting member to a developing area at which the developer supporting member and the electrostatic latent image supporting member are made face to face with each other; and
supplying the developer on the developer supporting member to the electrostatic latent image supporting member within the developing area.

16. The developing method according to claim 15, wherein the developer supporting member is a developing roller, and the regulating roller is allowed to counter-rotate against the developing roller, with a peripheral velocity ratio (regulating roller/developing roller) between the regulating roller and the developing roller being set to 3.00 or less.

17. The developing method according to claim 16, wherein the peripheral velocity ratio (regulating roller/developing roller) between the regulating roller and the developing roller is in the range from 0.20 to 1.50.

18. The developing method according to claim 15, wherein a voltage on the same polarity side as the polarity with which the developer is charged upon application of a voltage to the developer supporting member is applied to the regulating roller at the time when the developer thin-layer is formed.
